(19) United States
(12) Patent Application Publication
(10) Pub. No.: US 2024/0295077 A1
(43) Pub. Date: Sep. 5, 2024

(54) PRESS COVER FOR A SHOE PRESS AND CONVEYOR BELT HAVING IMPROVED PROPERTIES

(71) Applicant: Voith Patent GmbH, Heidenheim (DE)

(72) Inventors: Delphine Delmas, Heidenheim (DE); Uwe Matuschczyk, Geislingen (DE)

(21) Appl. No.: 18/573,586

(22) PCT Filed: Jul. 11, 2022
(86) PCT No.: PCT/EP2022/069220

§ 371 Date: Dec. 22, 2023

(30) Foreign Application Priority Data
Jul. 27, 2021 (DE) 10 2021 119 361.3

(51) Int. Cl. D21F 3/02; C08G 18/10; C08G 18/20; C08G 18/32; C08G 18/48; C08G 18/66

(52) U.S. Cl. CPC D21F 3/0227; C08G 18/10; C08G 18/2063; C08G 18/3206; C08G 18/3228; C08G 18/3271; C08G 18/4854; C08G 18/6688; D21F 3/0218

(57) ABSTRACT

A press cover is provided for a press roll, in particular for a press roll of a shoe press for dewatering a web of fibrous material, in particular a paper, cardboard, tissue or pulp web, or for a conveyor belt, in particular for a machine for producing or treating a web of fibrous material, in particular a paper, cardboard or tissue producing machine. The press cover or conveyor belt includes at least one polyurethane-containing layer. The polyurethane is formed by reacting a prepolymer and a crosslinker component. The prepolymer is a reaction product of phenylene 1,4-diisocyanate (PPDI) and of a polyol component containing at least one polyether polyol and/or at least one polycarbonate polyol. The crosslinker component contains a C₆₋₁₄ diol. A shoe press for dewatering of a fibrous material web and a machine for production or treatment of a fibrous material web, are also provided.

The present invention relates to a press cover for a press roll, especially for a press roll of a shoe press for dewatering of a fibrous material web, especially of a paper, cardboard, tissue or chemical pulp web, or conveyor belt, especially for a machine for production or treatment of a fibrous material web, especially a paper, cardboard or tissue machine, wherein the press cover or the conveyor belt comprises at least one polyurethane-containing layer. The present invention further relates to a process for producing such a press cover or conveyor belt, to a corresponding press cover and to a corresponding conveyor belt.

Press rolls are employed in a multitude of presses and for example in the form of shoe rolls in shoe presses, which are in turn used especially for dewatering fibrous material webs, such as paper webs. Such shoe presses are constructed from a shoe roll and an opposing roll, with a press nip formed between them. Shoe rolls here consist of a stationary, i.e., nonrotating, press element, namely the shoe, and of a flexible press cover which runs around the shoe. The shoe is typically supported by a yoke which carries it, and pressed via hydraulic press elements against the press cover running around these elements. Between the shoe and the press cover there is generally an oil film built up for lubrication. The concave architecture of the shoe at its side opposite the opposing roll produces a comparatively long press nip, which is about 20 times longer than that of conventional presses consisting of two rotating rolls.

In the operation of the shoe press, a fibrous material web is passed together with one or two press felt(s) through the press nip, wherein the liquid which emerges from the fibrous material web because of the pressure exerted on the fibrous material web in the press nip, this liquid containing not only water but also dissolved and undissolved compounds, such as fibers, fiber fragments, fillers and/or additives, for example, is temporarily taken up by the press felt and by depressions made in the press cover surface. After leaving the press nip, the liquid taken up by the press cover is spun off from the press cover, before the press cover enters the press nip again. Moreover, the water taken up by the press felt is removed with suction elements after it has left the press nip. Owing to the press nip, which is comparatively long because of the concave architecture of the shoe, a shoe press of this kind, in comparison to a press consisting of two rotating rolls, achieves substantially better dewatering of the fibrous material web, and so the subsequent thermal drying can be made shorter correspondingly. In this way, the dewatering of the fibrous material web that is achieved is particularly gentle.

A press cover of such a shoe press must ideally meet a multiplicity of requirements in order to lead to optimal results. First, such a press cover must be sufficiently flexible in order to be able to be passed around the shoe. At the same time, the press cover must be hard and stiff enough not to undergo excessive distortion and deformation under the pressing load prevailing in the press nip. A press cover, moreover, is required to exhibit high wear resistance, good abrasion resistance, low swelling in water and other properties, such as high cracking resistance, good resistance to crack propagation, and high resistance toward chemicals, such as, in particular, water, oil, acids, bases, and solvents.

In order to at least partly fulfill these manifold requirements, such press covers are typically made from fiber-reinforced polyurethane, i.e. from a composite material in which a fiber scrim or fiber weave is embedded in a matrix of crosslinked polyurethane. Both single-ply and corresponding multi-ply press covers are known here.

WO 2015/086555 A1 describes a press cover containing polyurethane, wherein the polyurethane has been obtained by reaction of a prepolymer formed from phenylene diisocyanate and polytetramethylene glycol. The reaction is conducted in the presence of a crosslinker component, wherein the crosslinker component may contain one or more of a multitude of different compounds.

EP 2 284 314 A1 discloses a press cover for a shoe press that is composed of one or more plies of crosslinked polyurethane with the fiber weave embedded therein. The crosslinked polyurethane here is the reaction product of a prepolymer produced from a polyol and from an isocyanate component containing 55 to 100 mol % of p-phenylene diisocyanate, and of a crosslinker component containing 65 to 100 mol % of one or more particular polyamines. The polyol is preferably polytetramethylene glycol.

EP 2 737 124 B1 discloses a press cover for a shoe press, or a conveyor belt, with the press cover or the conveyor belt comprising at least one layer that contains crosslinked polyurethane, wherein the crosslinked polyurethane is obtainable by a process in which a prepolymer, which is the reaction product of an isocyanate component containing methylene diphenyl diisocyanate and a polyol component containing a polycarbonate polyol, is reacted with a crosslinker component which contains at least one polyol having a weight-average molecular weight of more than 1000 g/mol.

WO 2017/129328 A1 discloses a press cover for a shoe press, wherein the press cover comprises at least one layer containing crosslinked polyurethane, wherein the crosslinked polyurethane is composed of a prepolymer formed from phenylene diisocyanate and a polyol that has been crosslinked by reaction with a crosslinker component, wherein the crosslinker component contains butane-1,4-diol or hydroquinone 1,4-bis(2-hydroxyethyl) ether and additionally an aliphatic diamine and an alkanolamine.

Although the press covers known from the latter publication have comparatively high stability to water and chemicals, the mechanical properties thereof and especially their hardness, modulus of elasticity, wear resistance, abrasion resistance and swelling in water are in need of improvement.

It is therefore an object of the present invention to provide a press cover or a conveyor belt, wherein the press cover or the conveyor belt has improved mechanical properties and especially improved hardness, an improved modulus of elasticity, improved wear resistance, improved abrasion resistance and improved swelling in water.

This object is achieved in accordance with the invention by the provision of a press cover for a press roll, especially for a press roll of a shoe press for dewatering of a fibrous material web, especially of a paper, cardboard, tissue or chemical pulp web, or conveyor belt, especially for a machine for production or treatment of a fibrous material web, especially a paper, cardboard or tissue machine, wherein the press cover or the conveyor belt comprises at least one polyurethane-containing layer, wherein the polyurethane has been formed by reacting a prepolymer and a crosslinker component, wherein the prepolymer is a reaction product of phenylene 1,4-diisocyanate (PPDI) and a polyol component containing at least one polyether polyol and/or at least one polycarbonate polyol, and wherein the crosslinker component contains a C₆₋₁₄ diol.

Surprisingly, in the context of the present invention, it has been found that a layer of polyurethane that has been obtained by crosslinking a prepolymer formed from the reaction product of PPDI and a polyol component containing at least one polyether polyol and/or at least one polycarbonate polyol with a crosslinker component containing at least one comparatively long diol, namely a C₆₋₁₄ diol, such as hexane-1,6-diol in particular, by comparison with a layer composed of the corresponding customary polyurethanes crosslinked with butane-1,4-diol, has improved hardness, an improved modulus of elasticity, improved wear resistance, improved abrasion resistance and improved (i.e. lower) swelling in water and hydrogen peroxide. Moreover, it was surprising that such a layer of polyurethane nevertheless features other good requisite properties, such as excellent cracking resistance, excellent crack propagation resistance and high resistance to chemicals, such as, in particular, water, oil, acids, bases and solvents. Although there have been isolated mentions in publications, for example for polyurethanes based on 4,4′-methylene diphenyl isocyanate (MDI), alongside butane-1,4-diol and other crosslinkers, of hexanediol, heptanediol, octanediol or the like in a catalog-like manner as possible crosslinker, this did not include any pointer to advantageous properties by comparison with butane-1,4-diol, let alone to the aforementioned advantageous properties compared to butane-1,4-diol. The aforementioned benefits are therefore also surprising especially because a person skilled in the art had to expect a longer crosslinker, namely a C₆₋₁₄ diol, such as hexane-1,6-diol in particular, by comparison with butane-1,4-diol, to lead to poorer separation of hard and soft segments and hence to a lower density of the hard segments, which leads to a lower hardness, to higher swelling in water and to worsened wear resistance of the polyurethane produced therefrom. Without wishing to be tied to any theory, it is considered to be the case that the aforementioned advantageous properties are attributable to the fact that the longer-chain C₆₋₁₄ diols, by comparison with butane-1,4-diol, lead to a greater proportion of hard segments in the polyurethane.

According to the invention, the crosslinker component of the polyurethane of the press cover or conveyor belt contains a C₆₋₁₄ diol, specifically irrespective of the position of the two hydroxyl groups in the C₆₋₁₄ diol. Therefore, the C₆₋₁₄ diol may be a corresponding diol having exclusively terminal hydroxyl groups, a corresponding diol having exclusively internal hydroxyl groups or a corresponding diol having one terminal and one internal hydroxyl group.

However, good results are obtained especially when the crosslinker component of the polyurethane contains a corresponding diol having exclusively terminal hydroxyl groups, i.e. a diol of the formula (I)

HO—(CH₂)ₓ—OH (I)

in which x is an integer from 6 to 14. x is preferably an integer from 6 to 12, more preferably an integer from 6 to 10 and most preferably an integer from 6 to 8.

x in the general formula (I) is preferably an integer which is a multiple of 2, i.e. 6, 8, 10, 12 or 14. Most preferably, x in the general formula (I) is 6, i.e. the diol is hexane-1,6-diol.

In order to obtain the above effects of the present invention to a particularly high degree, in a development of the concept of the invention, it is proposed that the crosslinker component, based on the total weight of the polyurethane, contains 2% to 15% by weight, preferably 3% to 11% by weight, further preferably 4% to 10% by weight and especially preferably 5% to 7% by weight of a C₆₋₁₄ diol and preferably of a diol of the general formula (I). In particular, it is preferable that the crosslinker component, based on the total weight of the polyurethane, contains 2% to 15% by weight, preferably 3% to 11% by weight, further preferably 4% to 10% by weight and especially preferably 5% to 7% by weight of hexane-1,6-diol.

The H/NCO stoichiometry, i.e. the ratio of the crosslinker component to the prepolymer, based on the moles thereof, is preferably 1.15 to 0.85 and more preferably 1.1 to 1.0.

In order to adjust the viscosity of the freshly crosslinked polyurethane to a viscosity which is suitable and especially sufficiently high for the production of the press cover or conveyor belt, for processability to give a press cover or conveyor belt, in a development of the concept of the invention, it is proposed that the crosslinker component, in addition to C₆₋₁₄ diol, contains at least one alkanolamine.

Good results are obtained especially when the at least one alkanolamine is a C₁₋₆-alkylmonohydroxymonoamine.

The at least one alkanolamine is preferably a compound of the general formula (II):

HO—(CH₂)ₙ₁—NH₂ (II)

in which n₁ is an integer from 1 to 6 and preferably from 1 to 4.

Most preferably, the at least one alkanolamine is monoethanolamine.

In a further preferred embodiment of the present invention, the crosslinker component, based on the total weight of the polyurethane, contains 0.01% to 2% by weight, further preferably 0.05% to 1% by weight and especially preferably 0.1% to 0.5% by weight of alkanolamine.

Preferably, the crosslinker component, based on the total weight of the crosslinker component, contains 0.01 to 15 mol % and preferably 5 to 10 mol % of alkanolamine.

In order to adjust the viscosity of the freshly crosslinked polyurethane to a viscosity which is suitable and especially sufficiently high for the production of the press cover or conveyor belt, for processability to give a press cover or conveyor belt, it is also possible to add at least one aliphatic diamine to the crosslinker component rather than the aforementioned alkanolamine. Alternatively, it is also possible that the crosslinker component, for establishment of the desired viscosity, contains both at least one alkanolamine and at least one aliphatic diamine.

Examples of suitable aliphatic diamines are aliphatic diamines selected from the group consisting of ethylenediamine (EDA), 2,2,4-trimethylhexane-1,6-diamine, 2,4,4-trimethyl-hexane-1,6-diamine, hexamethylenediamine (HMDA) and mixtures thereof.

Good results are obtained especially when the at least one aliphatic diamine is hexamethylenediamine (HMDA).

In a further preferred embodiment of the present invention, the crosslinker component, based on the total weight of the polyurethane, contains 0.01% to 2% by weight, preferably 0.05% to 1% by weight and more preferably 0.1% to 0.5% by weight of aliphatic diamine.

Preferably, the crosslinker component, based on the total weight of the crosslinker component, contains 0.1 to 10 mol % and preferably 2 to 8 mol % of aliphatic diamine.

In a development of the concept of the invention, it is proposed that the crosslinker component, in addition to the C₆₋₁₄ diol, contains at least one catalyst. The addition of at least one catalyst is preferred in order to achieve sufficiently rapid crosslinking of the polyurethane in order that the polyurethane does not remain liquid for too long during the processing and leads to corrugations on the surface of the press cover or the conveyor belt. The addition of catalyst to the crosslinker component is preferred, specifically irrespective of whether or not the crosslinker component, in addition to the at least one C₆₋₁₄ diol, contains at least one alkanolamine and/or at least one aliphatic diamine.

The catalyst is preferably at least one tertiary amine compound and/or at least one organometallic compound.

Good results are obtained especially when the at least one catalyst is a tertiary amine compound selected from the group consisting of 1,4-diazabicyclo(2.2.2)octane (DABCO), also called triethylenediamine (TEDA), triethylamine and mixtures thereof. Good results are likewise obtained when the at least one catalyst contains an organometallic compound having a metal selected from the group consisting of bismuth, mercury, aluminum, zirconium, iron, calcium, sodium, potassium, lead, tin, titanium and mixtures thereof.

More preferably, the at least one catalyst is 1,4-diazabicyclo(2.2.2)octane (DABCO) and/or bismuth neodecanoate.

In a further preferred embodiment of the present invention, the crosslinker component, based on the total weight of the polyurethane, contains 0.01% to 1% by weight, preferably 0.02% to 0.5% by weight and more preferably 0.05% to 0.2% by weight of tertiary amine compound and/or organometallic compound.

Preferably, the crosslinker component, based on the total weight of the crosslinker component, contains 0.01 to 5 mol % and preferably 1 to 3 mol % of tertiary amine compound.

In a development of the concept of the invention, it is proposed that the crosslinker component, in addition to the at least one C₆₋₁₄ diol, contains at least a polyether polyol and/or a polycarbonate polyol. This addition is preferred, specifically irrespective of whether the crosslinker component, in addition to the at least one C₆₋₁₄ diol, contains at least one alkanolamine and/or at least one aliphatic diamine and/or at least one catalyst. By the addition of polyether polyol or polycarbonate polyol, it is possible to finely adjust the hardness of the polyurethane.

Suitable examples of polyether polyol are those selected from the group consisting of polytetramethylene ether glycol (PTMEG), polypropylene glycol (PPG), polyethylene glycol (PEG), polyhexamethylene ether glycol and mixtures. Particular preference is given to polytetramethylene ether glycol (PTMEG).

Good results are obtained especially when the crosslinker component contains at least one polycarbonate polyol having the general formula (III):

—(O—R¹—O—C(O))ₙ₂—O— (III)

in which
R¹ is selected from linear C₁-C₂₀-alkylene groups and branched C₁-C₂₀-alkylene groups, and
n₂ is an integer from 3 to 30.

In an alternative embodiment, the polycarbonate polyol may also have different alkylene groups, such as, in particular, two, three or four different alkylene groups. For example, the polycarbonate polyol may have a first C₁-C₂₀-alkylene group A, such as a linear C₃-alkylene group, and a second C₁-C₂₀-alkylene group B which is different than the first, such as a linear C₆-alkylene group. The two groups may then be in an alternating, blockwise or random arrangement, for example ABAB, AAAB, AABB, BBAA or BAAA.

In a further preferred embodiment of the present invention, the crosslinker component, based on the total weight of the polyurethane, contains 0.1% to 15% by weight, preferably 0.5% to 10% by weight and more preferably 1% to 5% by weight of polyether polyol and/or polycarbonate polyol.

Preferably, the crosslinker component, based on the total weight of the crosslinker component, contains 0.1 to 15 mol % and preferably 0.5 to 10 mol % of polyether polyol and/or polycarbonate polyol.

In a development of the concept of the invention, it is proposed that the crosslinker component, based on the total weight of the polyurethane, contains:
2% to 15% by weight of a C₆₋₁₄ diol,
0.01% to 2% by weight of an alkanolamine,
0.01% to 2% by weight of an aliphatic diamine,
0.001% to 1% by weight of a tertiary amine compound and/or an organometallic compound and
0.1% to 15% by weight of a polyether polyol and/or a polycarbonate polyol.

Good results are obtained especially when the crosslinker component, based on the total weight of the polyurethane, contains:
2% to 15% by weight of hexane-1,6-diol,
0.01% to 2% by weight of a C₁₋₆-alkylmonohydroxymonoamine,
0.01% to 2% by weight of an aliphatic diamine selected from the group consisting of ethylenediamine, 2,2,4-trimethylhexane-1,6-diamine, 2,4,4-trimethylhexane-1,6-diamine and hexamethylenediamine,
0.001% to 1% by weight of 1,4-diazabicyclo(2.2.2)octane (DABCO) and/or an organometallic compound and
0.1% to 15% by weight of a polyether polyol.

Especially preferably, the crosslinker component, based on the total weight of the polyurethane, contains:
2% to 15% by weight of hexane-1,6-diol,
0.01% to 2% by weight of monoethanolamine,
0.01% to 2% by weight of hexamethylenediamine,
0.001% to 1% by weight of 1,4-diazabicyclo(2.2.2)octane (DABCO) and/or an organometallic compound and
0.1% to 15% by weight of polytetramethylene ether glycol.

In a further particularly preferred embodiment of the present invention, the crosslinker component of the polyurethane of the press cover or conveyor belt does not contain any aliphatic triol compound and preferably any triol compound at all, such as trimethylenepropane (TMP). The addition of a triol compound leads to a lower modulus of elasticity, to poorer cracking resistance, to poorer tear propagation resistance and to inadequate abrasion resistance of the polyurethane, specifically probably because these compounds disrupt the formation of hard segments in the polyurethane.

According to the invention, the polyol component of the prepolymer contains at least one polyether polyol and/or at least one polycarbonate polyol. In principle, the polyether polyol of the polyol component—like the optional polyether polyol of the crosslinker component—may be selected from the group consisting of polytetramethylene ether glycol (PTMEG), polypropylene glycol (PPG), polyethylene glycol (PEG), polyhexamethylene ether glycol and mixtures.

In a further very particularly preferred embodiment of the present invention, the polyol component contains a polytetramethylene glycol (PTMEG) as at least one polyether polyol or the polyol component consists entirely of a PTMEG. The specific combination of PPDI, PTMEG and C₆₋₁₄ diol as crosslinker leads to a particularly good improvement and balance of hardness, modulus of elasticity, wear resistance, abrasion resistance and swelling of the polyurethane of the press cover or conveyor belt.

Good results are obtained especially when the PTMEG has a weight-average molecular weight of 100 to 10 000 g/mol, preferably of 500 to 5000 g/mol, more preferably of 1000 to 3000 g/mol and most preferably of 1000 to 2500 g/mol. The molecular weight can be determined by gel permeation chromatography against a polystyrene standard. However, according to the present invention, it is preferable to determine the weight-average molecular weight of the structural units via the hydroxyl number, i.e. via that amount of potassium hydroxide in milligrams which is equivalent to the amount of acetic acid bound in the acetylation of 1 g of substance. The hydroxyl number can be effected by back-titration according to DIN 53240 and is reported in mg KOH/g. The weight-average molecular weight can be determined by division of 112 200 by the hydroxyl number.

Good results are also obtained when the polyol component contains a mixture of polyether polyol, preferably polytetramethylene glycol, and a polycarbonate polyol, and more preferably is a mixture of polyether polyol, preferably polytetramethylene glycol, and a polycarbonate polyol.

The polycarbonate polyol of the polyol component, irrespective of whether it is used alone or in a mixture with a polyether polyol, is preferably one of the general formula (IV):

—(O—R²—O—C(O))ₙ₃—O— (IV)

in which
R² is selected from linear C₁-C₂₀-alkylene groups and branched C₁-C₂₀-alkylene groups and
n₃ is an integer of at least 3.

In an alternative embodiment, the polycarbonate polyol may also have different alkylene groups, such as, in particular, two, three or four different alkylene groups. For example, the polycarbonate polyol may have a first C₁-C₂₀-alkylene group A, such as a linear C₃-alkylene group, and a second C₁-C₂₀-alkylene group B which is different than the first, such as a linear C₆-alkylene group. The two groups may then be in an alternating, blockwise or random arrangement, for example ABAB, AAAB, AABB, BBAA or BAAA.

The H/NCO ratio of the polyurethane is preferably between 1.1 and 1.0.

In order to further increase the abrasion resistance, it is also possible to add a silicone oil to the polyurethane as additive in an amount of 0.1% to 3% by weight and preferably 0.5% to 1.5% by weight, based on the total weight of the polyurethane.

For the reasons above, it is preferable that not just the crosslinker component but the polyurethane per se contains no aliphatic triol compound and preferably no triol compound.

It is further preferable when the polyurethane layer and, if more than one polyurethane layer are present, all polyurethane layers of the press cover or of the conveyor belt comprise(s) just one polyurethane, i.e. a polyurethane formed solely from one prepolymer by reaction of the prepolymer with a crosslinker component.

The press cover of the invention or the conveyor belt of the invention may take the form of a monolayer or bilayer. In the case of bilayer configuration, at least the outer layer is composed of the above-described polyurethane.

In a development of the concept of the invention, it is proposed that the press cover or the conveyor belt has a bilayer configuration, in which case the outer layer is composed of the above-described polyurethane and the inner layer is composed of another polyurethane, where the polyurethane of the inner layer forms the matrix in which a fiber scrim or a fiber weave is embedded.

The present invention further provides a shoe press for dewatering of a fibrous material web, especially a paper, cardboard, tissue or chemical pulp web, comprising an above-described press cover.

The present invention further relates to a machine for production or treatment of a fibrous material web, especially paper, cardboard or tissue machine, comprising an above-described conveyor belt.

Finally, the present invention relates to a process for producing an above-described press cover or conveyor belt, comprising the following steps:
a) providing at least one rotatably mounted winding mandrel,
b) providing an above-described crosslinker component,
c) providing a prepolymer as the product of a reaction of PPDI with an above-described polyol component,
d) mixing the prepolymer and the crosslinker component to produce a polyurethane,
e) discharging the prepolymer-crosslinker mixture on a surface of the winding mandrel to form at least one polymer layer of the press cover or the conveyor belt,
f) curing the at least one polymer layer and
g) removing the press cover or conveyor belt thus produced from the winding mandrel.

There follows a description of the present invention merely for illustrative purposes using advantageous embodiments and with reference to the appended drawings.

The figures show:

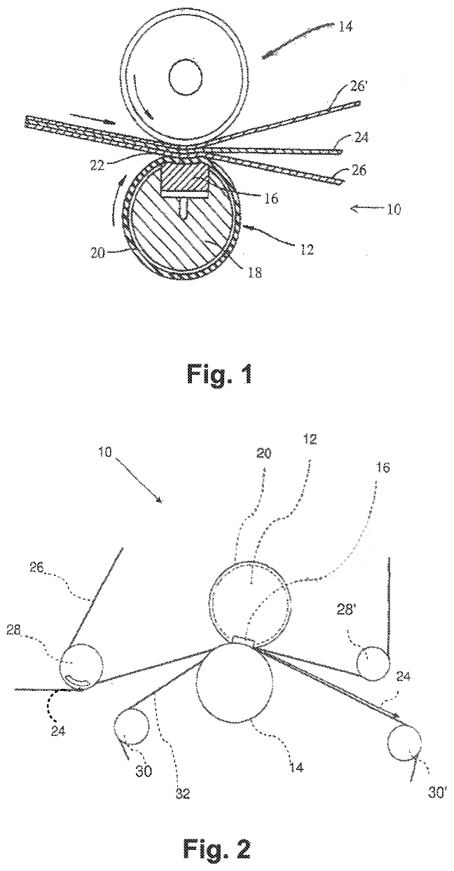

FIG. 1: a schematic view of a shoe press with a press cover according to a working example of the present invention and

FIG. 2: a schematic view of a press section of a paper machine comprising a shoe press and a conveyor belt, in one working example of the present invention.

FIG. 1 shows a shoe press 10 comprising a shoe roll 12 and an opposing roll 14. While the opposing roll 14 consists of a rotating, cylindrical roll, the shoe roll 12 is composed of a shoe 16, a stationary yoke 18 carrying said shoe, and a press cover 20. The shoe 16 here is supported by the yoke 18 and pressed via hydraulic press elements (not shown) against the press cover 20 running around these elements. Because of the concave architecture of the shoe 16, a comparatively long press nip 22 is produced at its side opposite the opposing roll 14.

The shoe press 10 is suitable especially for dewatering fibrous material webs 24, such as paper webs. In the operation of the shoe press, a fibrous material web 24 is passed with one or two press felts 26, 26′ through the press nip 22, wherein the liquid which emerges from the fibrous material web 24, owing to the pressure exerted on the fibrous material web 24 in the press nip 22, said liquid containing not only water but also dissolved and undissolved compounds, such as fibers, fiber fragments, fillers and/or additives, for example, is temporarily taken up by the press felt or the press felts 26, 26′ and by indentations (not shown) provided in the press cover surface. After having left the press nip 22, the liquid taken up by the press cover 20 is spun off from the press cover 20, before the press cover 20 enters the press nip 22 again. Moreover, after leaving the press nip 22, the water taken up by the press felt 26, 26′ is removed with suction elements.

Owing to the press nip 22, which is comparatively long because of the concave architecture of the shoe 16 on its side opposite the opposing roll 14, the dewatering of the fibrous material web 24 that is achieved with a shoe press 10 of this kind, in comparison to a press consisting of two rotating rolls, is considerably better, and so the subsequent thermal drying can be made shorter correspondingly. In this way the dewatering of the fibrous material web 24 that is achieved is particularly gentle.

FIG. 2 shows a detail of a press section of a paper machine, comprising a shoe press 10. In this case the shoe press 10, as in the case of the embodiment represented in FIG. 1 as well, comprises a shoe roll 12, having a press cover 20 and a press element or shoe 16, and an opposing roll 14, with a press nip being formed between the shoe 16 and the opposing roll 14. Moreover, this part of the paper machine comprises two suction rolls 28, 28′ and two deflection rolls 30, 30′. In the operation of the paper machine, a felt 26 guided through the suction rolls 28, 28′, and picking up the fibrous material web 24 at the suction roll 28, is passed through the press nip. Moreover, below the felt 26 carrying the fibrous material web 24, a conveyor belt or transfer belt 32, carried by the deflection rolls 30, 30′, is passed through the press nip, wherein in the press nip the fibrous material web 24 is taken over from the felt 26 by the transfer belt 32 and is taken off out of the press nip via the deflection roll 30′. Because of the pressure exerted on the fibrous material web 24 in the press nip, liquid emerges from the fibrous material web, and contains not only water but also dissolved and undissolved compounds, such as fibers, fiber fragments, fillers, and/or additives, for example, and which is taken up temporarily by the felt 26 and by indentations present in the press cover surface. After having left the press nip, the liquid taken up by the press cover 20 is spun off from the press cover 20, before the press cover 20 enters the press nip again. Moreover, after having left the press nip, the water taken up by the felt 26 is removed with suction elements provided on the suction roll 28′. Because of the press nip, which is comparatively long owing to the concave architecture of the shoe 16, a shoe press of this kind, in comparison to a press consisting of two rotating rolls, achieves substantially better dewatering of the fibrous material web 24, and so the subsequent thermal drying can be made shorter correspondingly. In this way the dewatering of the fibrous material web 24 that is achieved is particularly gentle.

There follows a description of the present invention merely for illustrative purposes using advantageous embodiments and with reference to the nonlimiting examples that are purely illustrative below.

### Example 1

The prepolymer used was the commercial product LFP E560 from Lanxess AG, Cologne, Germany, which is a prepolymer of PPDI and PTMEG having an NCO content of 5.6%.

In addition, a crosslinker component with the following composition was produced:

| | |
|---|---|
| 84.9% | molar hexane-1,6-diol (corresponding to 72.3% by |
| | weight, based on the crosslinker component) |
| 1.3% | molar PTMEG, 2000 g/mol (corresponding to 19.4% |
| | by weight, based on the crosslinker component) |
| 1.6% | molar DABCO (corresponding to 1.3% by weight, |
| | based on the crosslinker component) |
| 8.0% | molar monoethanolamine (corresponding to 3.5% by |
| | weight, based on the crosslinker component) |
| 4.2% | molar hexamethylenediamine (corresponding to 3.5% |
| | by weight, based on the crosslinker component) |

The press cover was, as known and described in DE 10 2017 115 084 A1 for example, produced by means of a rotatable winding mandrel, in that the prepolymer and the crosslinker component were supplied separately from one another to a casting device comprising a mixing chamber and, downstream thereof, a casting nozzle, with continuous intermixing of the prepolymer and the crosslinker component in the mixing chamber and then continuous application of the mixture thus produced via the casting nozzle to the rotating winding mandrel. The prepolymer and the crosslinker component were mixed with one another here in a ratio of 9.89 g of crosslinker component per 100 g of prepolymer.

In order to determine the properties of the polyurethane, polyurethane sheets were additionally produced by mixing the prepolymer and the crosslinker component together and then casting the mixture thus produced into the shape of sheets. The following were measured: Shore A hardness (measured to DIN 53505-A), Shore A hardness after hydrolysis, abrasion values (measured to DIN 53516) in mm, abrasion values after hydrolysis in mm, increase in weight in water in percent, increase in weight in hydrogen peroxide, modulus of elasticity in N/mm² (measured to DIN 53504) and F-(10%) in N/mm² (measured to DIN 53504). The measurement results are collated in the table that follows.

### Comparative Example 1

The procedure in example 1 was followed, except that the following crosslinker component was used:
84.9% molar 1,2-ethylene glycol
1.3% molar PTMEG, 2000 g/mol
1.6% molar DABCO
8.0% molar monoethanolamine
4.2% molar hexamethylenediamine

The measurement results are collated in the table that follows.

### Comparative Example 2

The procedure in example 1 was followed, except that the following crosslinker component was used:
84.9% molar butane-1,4-diol
1.3% molar PTMEG, 2000 g/mol
1.6% molar DABCO
8.0% molar monoethanolamine
4.2% molar hexamethylenediamine

The measurement results are collated in the table that follows.

| | | | Shore A | | Abrasion |
|---|---|---|---|---|---|
| | | | hardness | Abrasion | values |
| | | Shore A | after | values | (mm) after |
| Example | Index | hardness | hydrolysis | (mm) | hydrolysis |
| Ex. 1 | 100 | 98 | 97 | 15 | 33 |
| CEx. 1 | 100 | 97 | 95 | 23 | 109 |
| CEx. 2 | 100 | 97 | 97 | 17 | 41 |

Ex.—Example
CEx.—Comparative example

| | | Increase in | Increase | | |
|---|---|---|---|---|---|
| | | weight in | in weight | | |
| | | hydrogen | in water | E | F-(10%) |
| Example | Index | peroxide (%) | (%) | (N/mm²) | (N/mm²) |
| Ex. 1 | 100 | 4.1 | 1.6 | 141 | 8.8 |
| CEx. 1 | 100 | 4.5 | 2.1 | 107 | 6.7 |
| CEx. 2 | 100 | 4.3 | 1.7 | 129 | 8.4 |

Ex.—Example
CEx.—Comparative example.

### LIST OF REFERENCE NUMERALS

10 shoe press
12 shoe roll
14 opposing roll
16 shoe
18 stationary yoke
20 press cover
22 press nip
24 fibrous material web
26, 26′ press felt
28, 28′ suction rolls
30, 30′ deflection rolls
32 conveyor belt/transfer belt

1-19. (canceled)

20. A press cover for a press roll or for a press roll of a shoe press for dewatering a fibrous material web or a paper, cardboard, tissue or chemical pulp web, or a conveyor belt or a conveyor belt for a machine for production or treatment of a fibrous material web or a paper, cardboard or tissue web, the press cover or conveyor belt comprising:
at least one polyurethane-containing layer;
the polyurethane having been formed by reacting a prepolymer and a crosslinker component;
the prepolymer being a reaction product of phenylene 1,4-diisocyanate (PPDI) and a polyol component containing at least one of at least one polyether polyol or at least one polycarbonate polyol; and
the crosslinker component containing a C₆₋₁₄ diol.

21. The press cover or conveyor belt according to claim 20, wherein the crosslinker component contains a diol of having a formula HO—(CH₂)ₓ—OH, in which x is an integer from 6 to 14.

22. The press cover or conveyor belt according to claim 21, wherein x is 6, 8, 10, 12 or 14.

23. The press cover or conveyor belt according to claim 21, wherein the crosslinker component contains hexane-1,6-diol.

24. The press cover or conveyor belt according to claim 20, wherein the crosslinker component, based on a total weight of the polyurethane, contains 2% to 15% by weight of the C₆₋₁₄ diol.

25. The press cover or conveyor belt according to claim 24, wherein the diol has a general formula HO—(CH₂)ₓ—OH or is hexane-1,6-diol.

26. The press cover or conveyor belt according to claim 20, wherein the crosslinker component contains at least one alkanolamine.

27. The press cover or conveyor belt according to claim 26, wherein the at least one alkanolamine is a C₁₋₆-alkylmonohydroxymonoamine or monoethanolamine.

28. The press cover or conveyor belt according to claim 20, wherein the crosslinker component contains at least one aliphatic diamine.

29. The press cover or conveyor belt according to claim 28, wherein the at least one aliphatic diamine is selected from the group consisting of ethylenediamine (EDA), 2,2,4-trimethylhexane-1,6-diamine, 2,4,4-trimethylhexane-1,6-diamine, hexamethylenediamine (HMDA) and mixtures thereof, and hexamethylenediamine (HMDA).

30. The press cover or conveyor belt according to claim 20, wherein the crosslinker component contains at least one catalyst.

31. The press cover or conveyor belt according to claim 30, wherein the at least one catalyst is at least one of a tertiary amine compound or an organometallic compound.

32. The press cover or conveyor belt according to claim 20, wherein the crosslinker component contains at least one of a polyether polyol or a polycarbonate polyol.

33. The press cover or conveyor belt according to claim 20, wherein the crosslinker component does not contain any aliphatic triol compound or does not contain any triol compound.

34. The press cover or conveyor belt according to claim 20, wherein the polyol component contains polytetramethylene glycol as polyether polyol.

35. The press cover or conveyor belt according to claim 34, wherein the polytetramethylene glycol has a weight-average molecular weight of 100 to 10 000 g/mol.

36. The press cover or conveyor belt according to claim 34, wherein the polytetramethylene glycol has a weight-average molecular weight of 500 to 5000 g/mol.

37. The press cover or conveyor belt according to claim 34, wherein the polytetramethylene glycol has a weight-average molecular weight of 1000 to 3000 g/mol.

38. The press cover or conveyor belt according to claim 34, wherein the polytetramethylene glycol has a weight-average molecular weight of 1000 to 2500 g/mol.

39. The press cover or conveyor belt according to claim 20, wherein the crosslinker component, based on a total weight of the polyurethane, contains:
2% to 15% by weight of a C₆₋₁₄ diol,
0.01% to 2% by weight of an alkanolamine,
0.01% to 2% by weight of an aliphatic diamine,
0.001% to 1% by weight of at least one of a tertiary amine compound or an organometallic compound, and
0.1% to 15% by weight of at least one of a polyether polyol or a polycarbonate polyol.

40. The press cover or conveyor belt according to claim 39, wherein the crosslinker component, based on the total weight of the polyurethane, contains:
2% to 15% by weight of hexane-1,6-diol,
0.01% to 2% by weight of a C1-6-alkylmonohydroxymonoamine,
0.01% to 2% by weight of an aliphatic diamine selected from the group consisting of ethylenediamine, 2,2,4-trimethylhexane-1,6-diamine, 2,4,4-trimethylhexane-1,6-diamine and hexamethylenediamine,
0.001% to 1% by weight of at least one of 1,4-diazabicyclo(2.2.2) octane or an organometallic compound, and
0.1% to 15% by weight of a polyether polyol.

41. The press cover or conveyor belt according to claim 39, wherein the crosslinker component, based on the total weight of the polyurethane, contains:
2% to 15% by weight of hexane-1,6-diol,
0.01% to 2% by weight of monoethanolamine,
0.01% to 2% by weight of hexamethylenediamine,
0.001% to 1% by weight of at least one of 1,4-diazabicyclo(2.2.2) octane or an organometallic compound, and
0.1% to 15% by weight of polytetramethylene ether glycol.

42. The press cover or conveyor belt according to claim 40, wherein the crosslinker component, based on the total weight of the polyurethane, contains:
2% to 15% by weight of hexane-1,6-diol,
0.01% to 2% by weight of monoethanolamine,
0.01% to 2% by weight of hexamethylenediamine,
0.001% to 1% by weight of at least one of 1,4-diazabicyclo(2.2.2) octane or an organometallic compound, and
0.1% to 15% by weight of polytetramethylene ether glycol.

43. The press cover or conveyor belt according to claim 20, wherein the polyol component contains at least one polycarbonate polyol.

44. The press cover or conveyor belt according to claim 41, wherein the polycarbonate polyol has a general formula —(O—R¹—O—C(O))ₙ₃—O—, in which:
R¹ is selected from linear C₁-C₂₀-alkylene groups and branched C₁-C₂₀-alkylene groups, and
n₃ is an integer of at least 3.

45. The press cover or conveyor belt according to claim 42, wherein the polycarbonate polyol has a general formula —(O—R¹—O—C(O))ₙ₃—O—, in which:
R¹ is selected from linear C₁-C₂₀-alkylene groups and branched C₁-C₂₀-alkylene groups, and
n₃ is an integer of at least 3.

46. The press cover or conveyor belt according to claim 20, wherein the polyurethane does not contain any aliphatic triol compound or does not contain any triol compound.

47. A shoe press for dewatering a fibrous material web or a paper, cardboard, tissue or chemical pulp web, the shoe press comprising a press roll having a press cover according to claim 20.

48. A machine for production or treatment of a fibrous material web or a paper, cardboard or tissue web, the machine comprising a conveyor belt according to claim 20.
